(19) United States
(12) Patent Application Publication
(10) Pub. No.: US 2017/0076190 A1
(43) Pub. Date: Mar. 16, 2017

(54) DOCUMENT REPRODUCTION AND FINISHING SYSTEM AND METHOD

(71) Applicant: Océ-Technologies B.V., VENLO (NL)

(72) Inventor: Michael DUPRE, Venlo (NL)

(73) Assignee: Océ-Technologies B.V., VENLO (NL)

(21) Appl. No.: 15/361,170

(22) Filed: Nov. 25, 2016

Related U.S. Application Data
(63) Continuation of application No. PCT/EP2015/061551, filed on May 26, 2015.

(30) Foreign Application Priority Data
May 27, 2014 (EP) 14170099.7

(51) Int. Cl. G06K 15/00; G06F 3/12; G06K 15/02

(52) U.S. Cl. CPC G06K 15/4025; G06K 15/1822; G06K 15/1836; G06K 15/1813; G06F 3/1206; G06F 3/1248; G06F 3/1247; G06F 3/1264; G06K 2215/0014

(57) ABSTRACT

A document reproduction and finishing system includes a print engine, a finisher, and an electronic document data processing system adapted to convert a document data file into print data in a bit map level format suitable for controlling the print engine. The document data processing system includes an analysis section adapted to analyze the document data file and to identify therein any information that explicitly or implicitly specifies finisher marks, a finisher specifications storing section adapted to store finisher specifications that specify a format of finisher marks that the finisher is capable to read, and a mark generating section adapted to generate finisher marks on the basis of the information identified by the analysis section and in the format specified by the stored finisher specifications, and to insert the finisher marks into the print data.

### CROSS-REFERENCE TO RELATED APPLICATIONS

This application is a Continuation of International Application No. PCT/EP2015/061551, filed on May 26, 2015, and for which priority is claimed under 35 U.S.C. §120. PCT/EP2015/061551 claims priority under 35 U.S.C. §119 to application Ser. No. 14/170099.7, filed in Europe on May 27, 2014. The entirety of each of the above-identified applications is expressly incorporated herein by reference.

### BACKGROUND OF THE INVENTION

1. Field of the Invention:

The invention relates to a document reproduction and finishing system comprising: a print engine; a finisher; and an electronic document data processing system configured to convert a document data file into print data in a bit map level format suitable for controlling the print engine and comprising an analysis section configured to analyze the document data file and to identify therein any information that explicitly or implicitly specifies finisher instructions.

In the phrases “a print engine” and “a finisher”, the word “a” is an indefinite article, i.e. the phrases do not exclude the possibility that the system comprises a plurality of print engines and/or a plurality of finishers.

The term “finisher” as used here designates any apparatus that is capable of performing at least one finishing operation on printed single-sheet or multi-sheet documents. Examples of finishing operations include but are not limited to trimming, cutting, folding, punching, stapling, collating, binding, etc.

The term “document data file” is to designate an electronic file that includes information specifying the desired appearance of a printed document or a set of printed documents. Typically, this file includes not only information that specifies the image content of the printed pages but also information relating to print options such as color, simplex or duplex printing, and the like, as well as information specifying desired finishing options. The information concerning the finishing options may be included in a separate file, e.g. a Job Definition Format (JDF) ticket or an Application Programming Interface (API) that is distinct from the file that includes the image information. Nevertheless, the files relating to the image information and to the finishing options shall be jointly termed “document data file” in the present description.

For many finishing operations, such as trimming, cutting, folding, stapling or punching, it is necessary to specify desired positions where the finishing operations shall take place, e.g., the positions of trimming or cutting lines and folding lines, and the positions of punching holes and staples. This positional information may be included implicitly in the image content of the document, e.g. in the form of symbolic representations of cutting lines, staples, etc., or it may be included explicitly in the form of standardized finisher marks. Both manners will be further referred to as finisher marks. As an alternative, the positional information may take the form of instructions that are included in a JDF ticket or the like. The image information which may include the positional information relating to the finishing operations may take the form of a scanned image or bitmap or may be defined by a set of instructions in a Page Description Language (PDL). The term finisher instructions will be further referred to as also encompassing finishing marks as well as instructions included in a JDF ticket or the like and any instructions to control a finisher.

In any case, the information concerning the finishing options must eventually be encoded in a format that the finisher is capable to read and to interpret.

For example, trimming instructions should have a format that permits to precisely define the positions of the top, bottom, left and right edges of a sheet to be trimmed. There exists a large variety of formats for trimming instructions that fulfil these requirements.

In general, different finishers will require different formats for the finisher instructions. The required formats for a given finisher are included in the specifications of the finisher.

2. Background of the Invention:

In a conventional document reproduction process, the finisher instructions are created in accordance with the finisher specification and in accordance with the intent of the user when the document data file is being created.

U.S. Application Publication No. 2011/255099 A1 describes a system of the type indicated above, wherein the document data file is analyzed to identify finisher instructions that specify a finisher to be used for post processing. Then, specifications of the selected finisher are read from a database and markings that indicate a target position for the finishing operation, e.g. the position of a punch hole, are added to the image information to be printed. This permits a user to check, for example, whether the punch holes are formed at the correct positions.

U.S. Application Publication No. 2009/002779 A1 describes a method for automatically creating the finisher instructions as marks on the basis of specific features of the image contents of the document data file.

U.S. Pat. No. 7,092,963 B2 describes a document reproduction system, which includes a plurality of finishers. The finisher specifications are stored in a database that is used for controlling the finishing process for a print job in accordance with respective job specifications.

### SUMMARY OF THE INVENTION

It is an object of the invention to provide a system and method that offer more flexibility in a document reproduction and finishing process.

In the document reproduction and finishing system according to the invention, the document data processing system comprises:

a finisher specifications storing section configured to store finisher specifications (26) that specify finisher instructions in a format that the finisher is capable to read; and

a finisher instruction generating section configured to generate finisher instructions on the basis of the information identified by the analysis section and in the format specified by the stored finisher specifications, and to transfer the finisher instructions to the finisher.

In the system and method according to the invention, the final format of the finisher instructions is not determined at the time when the document data file is created, but at a later stage, when the document data file actually will be printed. Moreover, the finisher instructions are created by reference to the finisher specifications that have been read by the finisher specifications storing section.

This has the advantage that the decision, which finisher shall be used, may be postponed until the very moment when the document data file will be sent to the print engine.

For example, when a first finisher is connected to the print engine and a failure in this finisher occurs while a print job is waiting in the print queue, it is possible to remove the defective finisher and to replace it by another finisher that may have different specifications, without having to worry about the format of the finisher instructions. When the production process is continued and the print job has reached the top end of the queue, the document data processing system will assure that the format of the finisher instructions is automatically adapted to the specifications of the finisher that is now being used.

In an embodiment, the finisher instructions, specified by the finisher specifications, comprise finisher marks in the format that the finisher is capable to read; and the finisher instruction generating section comprises a mark generating section adapted to generate finisher marks on the basis of the information identified by the analysis section and in the format specified by the stored finisher specifications, and to insert these finisher marks into the print data.

The positional information is typically encoded in standardized finisher marks that are printed on the recording media together with the intended image content of the documents. The finisher includes optical detectors that are capable of detecting and interpreting finisher marks in a specific format, so that the finishing operations will be performed at the correct positions.

For example, trimming marks should have a format that permits to precisely define the positions of the top, bottom, left and right edges of a sheet to be trimmed, but should on the other hand not be visible on the final sheet. There exists a large variety of trimming mark formats that fulfil these requirements.

Similarly, when the reproduction and finishing system comprises a plurality of finishers and a distributor and conveyer system for directing the printed documents to a selected one of the finishers, the selection of the finisher that shall be used for a specific print job may be postponed until the print engine is about to start processing this print job.

More specific optional features of the invention are indicated in the dependent claims.

The non-converted document data file may already include explicit information that specifies finisher marks in any standard format. Then, the analysis section will identify this information and check whether the format of the identified finisher marks is compatible with the specifications of the finisher that is actually to be used. When the format is not compatible, the finisher marks are erased and replaced by new finisher marks that confer the same positional information but have a format that is compatible with the finisher.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram of a document reproduction and finishing system according to an embodiment of the invention; and

FIG. 2 is a flow diagram illustrating a document reproduction and finishing method according to an embodiment of the invention.

### DETAILED DESCRIPTION OF THE PREFERRED EMBODIMENTS

The present invention will now be described with reference to the accompanying drawings, wherein the same or similar elements are identified with the same reference numeral.

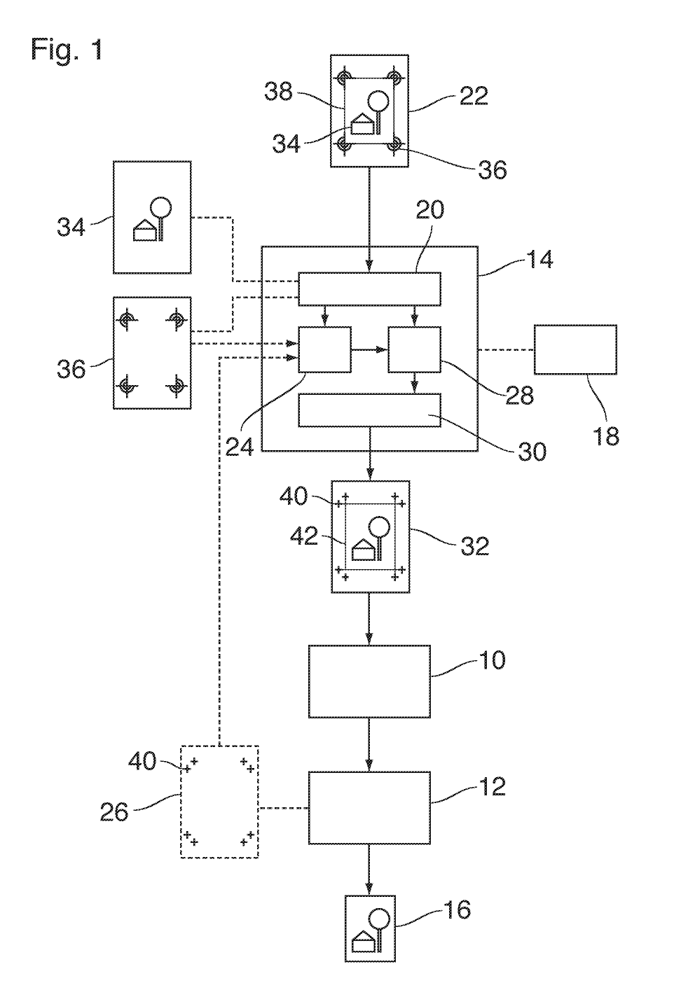

The document reproduction and finishing system shown in FIG. 1 comprises a digital print engine 10, a finisher 12 and an electronic document data processing system 14.

The finisher 12 may be physically connected to the print engine 10, so that the documents that have been printed in the print engine are readily transferred to the finisher, which applies the desired finishing operations and outputs printed products 16.

As an alternative, the finisher 12 may be installed separately from the print engine 10, so that the printed media sheets that are discharged from the print engine 10 have to be transferred to the finisher 12 manually.

According to yet another alternative, the finisher 12 may be one of a plurality of finishers that are connected to the print engine 10 via a distributor and conveyer system that will direct the printed copies to a finisher that has been selected automatically by the document data processing system 14 or has been selected manually by a user via a user interface 18 of the document data processing system.

The document data processing system 14 comprises an analysis section 20 for analyzing a document data file 22 that specifies a document to be printed in a print job. Further, the document data processing system 14 includes a finisher specifications storing section 24 adapted to store finisher specifications 26 of the finisher 12, a mark generating section 28, and a raster image processor 30 adapted to convert the document data file 22, including finisher marks generated in the mark generating section 28, into print data 32. The print data 32 are constituted by a bit map or, more generally, have a bit map level format that is suitable for directly controlling the print engine 10 so that the image information contained in the bit map will be recorded on the print media.

The document data file 22 may be a file that has been generated on a remote workstation and has been sent to the document reproduction system via a network or has temporarily been stored on a storage medium that has then been physically connected or plugged-in at the document reproduction system. By way of example, it shall be assumed here that the document data file 22 has been set-up in a page description language (PDL). As an alternative, it would however also be possible that the document data file has been obtained by scanning an original and has been sent to the document reproduction system in any other format, such PDF, TIFF or the like.

In the example shown, the document that is represented by the document data file 22 comprises graphical image content 34 as well as four finisher marks (trimming marks) 36 that define trimming lines 38 along which the printed sheet shall be trimmed in the finisher 12.

The finisher marks 36 have a pre-defined format that is compatible with finisher specifications of a certain type of finisher.

The analysis section 20 analyzes the document data file 22 and separates or extracts the finisher marks 36 from the image content 34, as has symbolically been shown on the left side in FIG. 1.

When the document data file 22 is a PDL document, the finisher marks 36 are identified and extracted by interpretation of the PDL commands. When the document data file 22 is in a bit map level format, the finisher marks 36 may be identified and extracted by applying suitable image processing routines.

The finisher marks storing section 24 receives the finisher specifications 26 from the finisher 12 that is presently connected to the print engine 10 or has been selected for finishing the printed products created in the print job. The finisher specifications 26 may take the form of an electronic data stream that is sent to the finisher specifications storing sections 24 via a cable, when the finisher is physically connected to the print engine. As an alternative, the finisher specifications 26 may be transmitted to the document data processing system 14 via a network or via an intermediate storage medium such as a memory stick.

In the example shown, the finisher specifications 26 specify a format of finisher marks 40 which, however, is different from the format of the finisher marks 36 in the document data file 22.

The finisher marks storing section 24 receives from the analysis section 20 the format of the extracted finisher marks 36 and compares this format to the format of the finisher marks 40 in the finisher specifications 26. When the two formats are found to be compatible (which they are not in the present example), the document data file 22 is forwarded to the raster image processor 30 without any changes. When the formats are not compatible, only the image content 34 without the finisher marks 36 is forwarded to the mark creation section 28, and the mark creation section 28 creates new finisher marks 40 in the format compatible with the finisher specifications 26 and inserts them into the document file in such positions that they define cutting lines 42 exactly in the same positions as the cutting lines 38. Then, the document data file with the new finisher marks 40 is forwarded to the raster image processor 30 and converted, so that the print data 32 that will actually be printed by the print engine 10 correspond to a superposition of the image content 34 and the finisher marks 40.

The finisher 12 is capable of detecting and interpreting the finisher marks 40 correctly and will cut the printed media sheets along the specified cutting lines 42 so as to obtain the desired printed product 16.

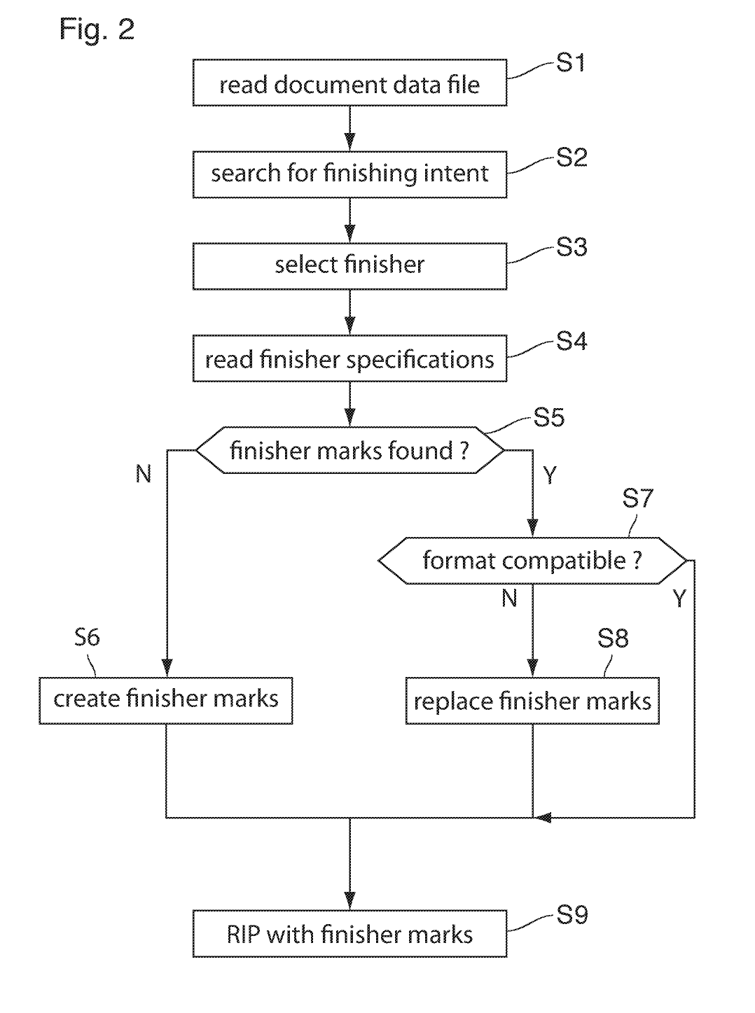

A more general version of the document reproduction and finishing method according to the invention will now be described by reference to the flow diagram shown in FIG. 2.

In step S1, the document data file is read.

In step S2, the analysis section 20 searches the document data file for finishing intent, i.e. for any information that can be interpreted as an implicit or explicit specification of finisher marks. The finishing intent may take the form of standardized finisher marks in a format compatible with the specifications of any existing finisher or it may take the form of non-standard (user defined) finisher marks, or it may even be encoded in the image content itself. For example, the finishing intent may be recognized by searching for a specific color or line width that is used exclusively for finisher marks.

In the step S2, the analysis section may also identify the finishing intent, i.e. information about the finishing operations to be performed and about the capabilities of the finisher are required for that purpose. If a plurality of finishers is available, then, the analysis section 20 may, in step S3, automatically select a suitable finisher on the basis of the analysis result, i.e. a finisher that fulfils the requirements imposed by the finishing intent.

Then, in step S4, the finisher specifications storing section 28 reads the finisher specifications of the selected finisher and identifies the required format of the finisher marks.

Step S5 is a query asking whether any standard or non-standard finisher marks have been found in the search step S2. If that is not the case (N), i.e. if the finishing intent has been encoded in some other way, e.g. in a JDF ticket, then the corresponding finisher marks are created in step S6 in a format compatible with the finisher specifications read in step S4.

On the other hand, when finisher marks have been found in step S5, it is checked in step S7 whether the format of the finisher marks that have been found is compatible with the format required by the finisher specifications read in step S4. If that is not the case (N), the old finisher marks are erased and replaced by new ones in the required format in step S8. Otherwise, if the formats have been found to be compatible (Y), the step S8 is skipped.

Subsequent to step S6, S7 or S8, the document data file with the newly created or replaced finisher marks is subjected to raster image processing in step S9, thus assuring that the finisher marks on the printed media sheets can be read and interpreted correctly by the finisher 12.

In an alternative embodiment of the invention, the finisher is configured to receive finishing instructions as commands in a particular format transferred to the finisher via a command line and thus separate from the print data. This may imply that finishing marks present in a document data file received by the electronic data processing system are erased when converting the document data file into print data.

The embodiment described before and the alternative embodiment may be used in combination.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A document reproduction and finishing system comprising:
a print engine;
a finisher; and
an electronic document data processing system adapted to convert a document data file into print data in a bit map level format suitable for controlling the print engine, the electronic document data processing system comprising:
an analysis section configured to analyze the document data file and to identify therein any information that explicitly or implicitly specifies finisher instructions;
a finisher specifications storing section configured to store finisher specifications that specify finisher instructions in a format that the finisher is capable to read; and
a finisher instruction generating section configured to generate finisher instructions on the basis of the information identified by the analysis section and in the format specified by the stored finisher specifications, and to transfer the finisher instructions to the finisher.

2. The document reproduction and finishing system according to claim 1,
wherein the finisher instructions, specified by the finisher specifications, comprise finisher marks in the format that the finisher is capable to read, and
wherein the finisher instruction generating section comprises a mark generating section adapted to generate finisher marks on the basis of the information identified by the analysis section and in the format specified by the stored finisher specifications, and to insert the finisher marks into the print data.

3. A document reproduction and finishing method comprising the steps of:
(a) analyzing a document data file for identifying therein any information that explicitly or implicitly specifies finisher instructions;
(b) storing finisher specifications of a finisher that is to be used for finishing the printed documents, said finisher specifications specifying finisher instructions in a format that the finisher is capable to read;
(c) generating finisher instructions on the basis of the information identified in the step (a) and in the format specified by the stored finisher specifications; and
(d) converting the document data file into print data, the print data having a bit map level format suitable for controlling a print engine; and
(e) transferring the finisher instructions generated in the step (c) to the finisher.

4. The document reproduction and finishing method according to claim 3,
wherein the finisher instructions, specified by the finisher specifications, comprise finisher marks in the format that the finisher is capable to read,
wherein the step (c) comprises the step of generating finisher marks in the format specified by the stored finisher specifications, and
wherein the step (e) comprises the step of including the finisher marks into the print data when converting the document data file.

5. The document reproduction and finishing method according to claim 4,
wherein the step (a) includes the step of searching for finisher marks explicitly included in the document data file (22), and
wherein the step (c) includes the step of erasing the finisher marks found in the step (a) and replacing the finisher marks found in the step a by the generated finisher marks.

6. The document reproduction and finishing method according to claim 3, further comprising the step of selecting one of a plurality of finishers for finishing the printed documents,
wherein the step of selecting is performed prior to the step (b).

7. The document reproduction and finishing method according to claim 4, further comprising the step of selecting one of a plurality of finishers for finishing the printed documents,
wherein the step of selecting is performed prior to the step (b).

8. The document reproduction and finishing method according to claim 5, further comprising the step of selecting one of a plurality of finishers for finishing the printed documents,
wherein the step of selecting is performed prior to the step (b).

9. The document reproduction and finishing method according to claim 6, wherein the step of selecting is performed after the step (a).

10. The document reproduction and finishing method according to claim 7, wherein the step of selecting is performed after the step (a).

11. The document reproduction and finishing method according to claim 8, wherein the step of selecting is performed after the step (a).
